(19) United States
(12) Patent Application Publication
(10) Pub. No.: US 2025/0373042 A1
(43) Pub. Date: Dec. 4, 2025

(54) ELECTROMECHANICAL ACTUATOR FOR A SUN PROTECTION OR A PRIVACY DEVICE

(71) Applicant: SOMFY ACTIVITES SA, CLUSES (FR)

(72) Inventors: Quentin WERLE, Cluses (FR); Cédric FERNANDEZ, Cluses (FR)

(21) Appl. No.: 19/219,180

(22) Filed: May 27, 2025

(30) Foreign Application Priority Data
May 31, 2024 (FR) 2405712

(51) Int. Cl. H02J 7/00; E06B 9/24; E06B 9/42; E06B 9/72; H02K 7/102; H02K 7/116; H02K 11/00; H02S 10/20

(52) U.S. Cl. CPC H02J 7/0068; E06B 9/42; E06B 9/72; H02J 7/0029; H02K 7/102; H02K 7/116; H02K 11/0094; H02S 10/20; E06B 2009/2476; H02K 2207/03

(57) ABSTRACT

An electromechanical actuator for a sun protection or a privacy device, the electromechanical actuator comprising:
an electric motor (16)
an electronic control unit (15),
a rechargeable battery (18), and
a connector (28) to a photovoltaic solar panel (37) or to a charger (44), the electronic control unit (15) comprising:
a charging circuit (32) connected to the rechargeable battery (18) and electrically connected to the connector (28) via a power supply bus (34),
a controller (31), and
detector (39) for detecting a connection of the photovoltaic solar panel (37) to the connector (28),
a first switch (38), the first switch (38) being connected to the connector (28) via the power supply bus (34) and to the rechargeable battery (18).

The controller (31) commands the first switch (38) to a closed state when a connection of a photovoltaic solar panel (37) to the connector (28) is detected, so as to electrically connect the power supply bus (34) to the connection device to the rechargeable battery (18).

This application claims priority under 35 U.S.C. § 119 to French Patent Application No. FR 2405712, filed on May 31, 2024. The disclosure of this application is incorporated herein by reference in its entirety.

### TECHNICAL FIELD OF THE INVENTION

The present invention relates to an electromechanical actuator for a sun protection or a privacy device.

### PRIOR ART

An electromechanical actuator for a sun protection or a privacy device installed at an opening of a building, comprises an electronic control unit and a rechargeable battery. The rechargeable battery supplies the electronic control unit, as well as the electric motor of the electromechanical actuator when the electromechanical actuator is in operation.

It is known, in a first mode of charging the rechargeable battery, to charge the rechargeable battery with the electrical energy produced by a photovoltaic solar panel external to the electromechanical actuator, the photovoltaic solar panel being connected to the electromechanical actuator via a connector, and arranged at the opening of the building in such a way that the photovoltaic solar panel produces electrical energy when exposed to solar radiation.

It is also known, in a second mode of charging the rechargeable battery, to charge the rechargeable battery with the electrical energy of a charger external to the electromechanical actuator, the charger being connected to the electromechanical actuator via a power supply connector. In such case, the electronic control unit comprises a charging circuit for the rechargeable battery which is electrically connected to the power supply connector via a power supply bus, the charging circuit being connected to the rechargeable battery in order to charge the rechargeable battery from the energy present in the power supply bus.

When an electromechanical actuator integrates the two charging modes of the rechargeable battery, and in the first charging mode, the rechargeable battery is charged with the electrical energy produced by the photovoltaic solar panel via the charging circuit, a drawback is that the efficiency of the charging circuit is degraded compared to the second charging mode of the rechargeable battery, thereby increasing the overall consumption of the electromechanical actuator when connected to the photovoltaic solar panel.

Therefore, there is a need to minimize the overall consumption of an electromechanical actuator in a first charging mode when the latter is connected to a photovoltaic solar panel to charge the rechargeable battery of the electromechanical actuator, while keeping the possibility of charging the rechargeable battery with the electrical energy from a charger via a charging circuit.

### SUMMARY OF THE INVENTION

The subject matter of the present invention is then an electromechanical actuator for a sun protection or a privacy device, the electromechanical actuator comprising at least:
an electric motor,
an electronic control unit,
means of connection to at least one rechargeable battery, and
a connector, the connector being intended to be connected to a photovoltaic solar panel or to a charger,
the electronic control unit comprising at least:
a charging circuit, the charging circuit being, on the one hand, connected to the means of connection to the at least one rechargeable battery, and, on the other hand, electrically connected to the connector via a power supply bus,
a controller, and
means of detection of a connection of the photovoltaic solar panel to the connector,
the electronic control unit further comprising at least:
a first switch, the first switch being connected, on the one hand, to the connector via the power supply bus and, on the other hand, to the means of connection to the at least one rechargeable battery, and
the controller being configured to control the first switch in a closed state by a first controllable output of the controller when a connection of a photovoltaic solar panel to the connector is detected, so as to electrically connect the power supply bus to the means of connection to the at least one rechargeable battery.

In an advantageous example, the first switch is connected in parallel with the charging circuit so that the first switch short-circuits the charging circuit when the first switch is controlled by the first controllable output of the controller.

The consumption of the electromechanical actuator is improved since the consumption no longer implements or at least very partially implements the charging circuit, the efficiency of which would be poor if the circuit were to transform the current coming from the photovoltaic solar panel.

According to an additional feature, the first output electrically connects the power supply bus to the means of connection to the at least one rechargeable battery via a diode so that a current coming from the rechargeable battery is blocked toward the power supply bus.

Thanks to the implementation of a diode, a current coming from the rechargeable battery is blocked toward the power supply bus and the risk of damage is reduced. Advantageously, the connector is a USB Type-C connector, the controller is a USB Type-C controller, and the USB Type-C controller is connected to at least one communication pin of the Universal Serial Bus Type-C connector via a communication bus.

In a particularly advantageous embodiment, the electronic control unit further comprises at least:
a protection circuit, the protection circuit being connected to the connector via a communication bus, and comprising a voltage input, the voltage input being connected to the power supply bus via a resistor bridge, and
a second switch, the second switch being connected, on the one hand, to the supply bus, and, on the other hand, to the charging circuit, the second switch being controlled in an open state by the protection circuit when the protection circuit detects an overvoltage at the voltage input,
the controller further comprising a second controllable output electrically connected to the voltage input, and
the controller being configured to control the second controllable output when the connection of the photovoltaic solar panel to the connector is detected, so as to simulate an overvoltage at the voltage input.

The implementation of a protection circuit by cooperating with a second switch makes it possible to detect an overvoltage in the power supply bus and, in response, to interrupt the flow of a current in the power supply bus between the connector and the charging circuit in order to protect the charging circuit from the overvoltage. The invention advantageously uses the protection circuit to isolate the charging circuit by opening the second switch.

According to an additional feature, the second controllable output is connected to the voltage input via a resistor and a Zener diode which are connected together in series.

Advantageously, the connector is a USB Type-C connector, the controller is a USB Type-C controller, and the protection circuit is a USB Type-C port protection circuit The implementation of a USB Type-C connector can be used both for charging the battery and a data exchange between the charging device and the actuator.

A further subject-matter of the present invention relates to a sun protection or a privacy device comprising at least one roller tube, a screen which can be rolled around the roller tube, an electromechanical actuator configured according to the invention, the electromechanical actuator furthermore being configured to rotate the roller tube, the electromechanical actuator further comprising a torque support, the torque support comprising the connector.

The connector on the torque support is easily accessible.

A further subject-matter of the present invention relates to a method for charging at least one rechargeable battery configured to supply an electromechanical actuator for a sun protection or a privacy device, the electromechanical actuator being configured according to the invention, the method being implemented by the electronic control unit, and comprising at least:
a step of detecting a connection of the photovoltaic solar panel to the connector,
when a connection of the photovoltaic solar panel to the connector is detected, a step of controlling the first switch in a closed state, so as to electrically connect the power supply bus to the means of connection to the at least one rechargeable battery.

A further subject-matter of the present invention relates to a method for charging at least one rechargeable battery configured to supply an electromechanical actuator for a sun protection or a privacy device, the electromechanical actuator being configured according to the invention, the method being implemented by the electronic control unit, and comprising at least:
a step of detecting a connection of the photovoltaic solar panel to the connector,
when a connection of the photovoltaic solar panel to the connector is detected, a first step of controlling the first switch in a closed state, so as to electrically connect the power supply bus to the means of connection to the at least one rechargeable battery, and
when a connection of the photovoltaic solar panel to the connector is detected, a step of controlling the second controllable output so as to simulate an overvoltage at the voltage input making the second switch to switch to the open state.

The subject-matter of the present invention is further a rechargeable battery power supply module comprising:
an electronic control unit
means of connection to a rechargeable battery, and
a connector intended to be connected to a photovoltaic solar panel or to a charger,
the electronic control unit comprising at least:
a charging circuit, the charging circuit being, on the one hand, connected to the means of connection to the rechargeable battery and, on the other hand, electrically connected via a power supply bus to the connector,
a controller,
means of detection of a connection of the photovoltaic solar panel to the connector,
the electronic control unit further comprising at least:
a first switch, the first switch being connected, on the one hand, to the connector via the power supply bus, and, on the other hand, to the means of connection to the rechargeable battery,
and the controller being configured to control
the first switch in a closed state by means of a first controllable output of the controller when a connection of a photovoltaic solar panel to the connector is detected, so as to electrically connect the power supply bus to the means of connection to the rechargeable battery.

In an advantageous example, the electronic control unit of the power supply module further comprises at least:
a protection circuit, the protection circuit being connected to the connector via a communication bus, and comprising a voltage input, the voltage input being connected to the power supply bus via a resistor bridge, and a second switch, the second switch being connected, on the one hand, to the power supply bus and, on the other hand, to the charging circuit, the second switch is controlled in an open state by the protection circuit when the protection circuit detects an overvoltage at the voltage input,
and the controller further comprising a second controllable output electrically connected to the voltage input,
and the controller being configured to control the second controllable output when the connection of the photovoltaic solar panel to the power supply connector is detected, so as to simulate an overvoltage at the voltage input.

The power supply module may be fitted to any device powered by at least one rechargeable battery able to be recharged either by a photovoltaic solar panel or by a charger.

### BRIEF DESCRIPTION OF FIGURES

The present invention will be better understood with the help of the following description and of the appended drawings wherein:

FIG. 1 is a side view of an example of embodiment of a shading device to which the invention applies,

FIG. 2 is a front view of an example of an electromechanical actuator according to the invention,

FIG. 3 is a perspective view of a detail of the electromechanical actuator at the torque support,

FIG. 4 is a schematic representation of an electronic control unit according to a first embodiment of the invention,

FIG. 5 is a schematic representation of an electronic control unit according to a second embodiment of the invention.

### DETAILED DESCRIPTION

In the present application, “connect” refers to directly electrically connect two electrical and/or electronic elements, and the term “electrically connect” means establishing an electrical connection between two electrical and/or electronic elements, other functional elements being interposed between the two electrical and/or electronic elements. Functional elements are electrical and/or electronic elements other than electrical conductors such as wire or conductive track.

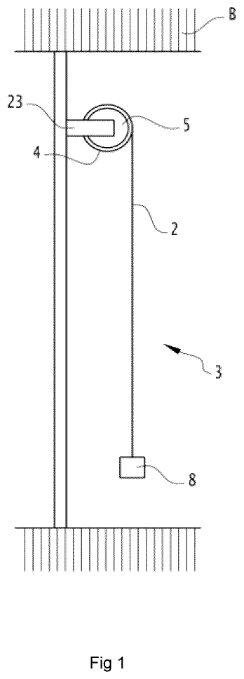

An example of a sun protection or a privacy device 3 is described first of all with reference to FIG. 1. Hereinafter, the privacy device, or sun protection device, is called the “shading device”.

The shading device 3 may be a blind, in particular a blind comprising a roll-up fabric, or a pleated or honeycomb fabric, or a blind with orientable slats. The present invention applies to all types of privacy device.

The shading device 3 comprises a motorized drive device 5 for driving a screen 2, the motorized drive device 5 being positioned at an opening of a building B in order to move the screen 2 relative to the opening of the building B. The shading device 3 comprises the screen 2.

The screen 2 is e.g. formed of a roll-up fabric, or of a pleated or honeycomb fabric, or else formed from orientable slats.

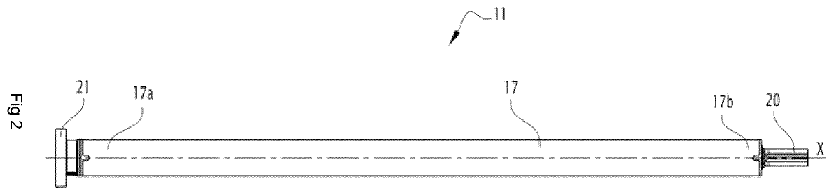

The motorized drive device 5 further comprises an electromechanical actuator 11, illustrated in FIG. 2.

The shading device 3 further comprises a roller tube 4. The screen 2 can be rolled around the roller tube 4. Furthermore, the roller tube 4 is arranged so as to be rotated by the electromechanical actuator 11.

Thereby, the screen 2 of the shading device 3 is rolled around the roller tube 4 or unrolled from same, the roller tube 4 being driven by the motorized drive device 5, more particularly by the electromechanical actuator 11.

In this way, the screen 2 is movable between a rolled-up position, more particularly an upper position, and an unrolled position, more particularly a lower position, and vice versa.

The screen 2 of the shading device 3 is a privacy and/or sun protection screen, rolled and unrolled around the roller tube 4, the inside diameter of which is greater than the outside diameter of the electromechanical actuator 11, so that the electromechanical actuator 11 can be inserted into the roller tube 4, during the assembly of the shading device 3.

The shading device 3 further comprises a load bar 8 for exerting tension on the screen 2. A first end of the screen 2, more particularly the upper end of the screen 2, in an assembled configuration of the shading device 3, is fastened to the roller tube 4. Furthermore, a second end of the screen 2, more particularly the lower end of the screen 2, in the assembled configuration of the shading device 3, is fastened to the load bar 8.

The electromechanical actuator 11, more particularly a tubular electromechanical actuator, makes it possible to rotate the roller tube 4 about an axis of rotation X, so as to move, more particularly roll or unroll, the screen 2 of the shading device 3.

In a mounted state of the shading device 3, the electromechanical actuator 11 is inserted into the roller tube 4.

The shading device 3 comprises a holding device 23. The holding device 23 may comprise two supports. The supports are each arranged at one end of the roller tube 4, more particularly in the assembled configuration of the shading device 3. Thereby, the roller tube 4 is held by means of the supports. The supports serve to mechanically connect the shading device 3 to the structure of building B, in particular to a wall of building B.

The electromechanical actuator 11 according to an example of embodiment, but not limited to, will now be described with reference to FIGS. 2 to 4.

The electromechanical actuator 11 comprises an electronic control unit 15, an electric motor 16, and means of connection 19 to at least one rechargeable battery 18. The electronic control unit 15 is connected, on the one hand, to the rechargeable battery 18 by means of the means of connection 19 and, on the other hand, to the electric motor 16.

The electromechanical actuator 11 further comprises a casing 17, more particularly a tubular and hollow casing. The electric motor 16 is mounted inside the casing 17, more particularly in an assembled configuration of the electromechanical actuator 11.

Advantageously, the at least one rechargeable battery 18 is mounted inside the casing 17, more particularly in the assembled configuration of the electromechanical actuator 11, the electromechanical actuator 11 comprising herein the at least one rechargeable battery 18.

In a variant, the at least one rechargeable battery 18 is external to the electromechanical actuator 11, the means of connection 19 extending in such case through the torque support 21, the means of connection 19 comprising e.g. a dedicated power supply connector arranged at the torque support 21 and a power supply cable connecting the at least one rechargeable battery 18 to the electronic control unit 15 via the dedicated power supply connector.

The casing 17 comprises a first end 17a and a second end 17b. The second end 17b is opposite the first end 17a. Herein, the casing 17 of the electromechanical actuator 11 has a cylindrical shape, in particular a shape of revolution about the axis of rotation X, and is open at each of the ends 17a, 17b thereof.

The electromechanical actuator 11 further comprises an output shaft 20. The output shaft 20 is arranged, in other words is configured to be arranged, on the side of the second end 17b of the casing 17, more particularly in the assembled configuration of the electromechanical actuator 11.

The electromechanical actuator 11 further comprises a reduction gear. The reduction gear is coupled, in other words configured to be coupled, with the electric motor 16 in the assembled configuration of the electromechanical actuator 11.

The electromechanical actuator 11 further comprises a brake. The brake is configured to brake and/or to lock the output shaft 20 in rotation, so as to regulate the speed of rotation of the roller tube 4, during a movement of the screen 2, and to keep the roller tube 4 locked, when the electric motor 16 is electrically deactivated. The reduction gear and, if appropriate, the brake are mounted inside the casing 17 of the electromechanical actuator 11, more particularly in the assembled configuration of the electromechanical actuator 11.

The electromechanical actuator 11 further comprises a ring, in other words a sleeve. The ring is configured to be arranged, in other words is arranged, at the first end 17a of the casing 17, more particularly in the assembled configuration of the electromechanical actuator 11.

The ring forms, in other words is configured to form or to be a bearing for guiding the roller tube 4 in rotation around the casing 17 of the electromechanical actuator 11, more particularly an assembled configuration of the motorized drive device 5, and hence of the shading device 3.

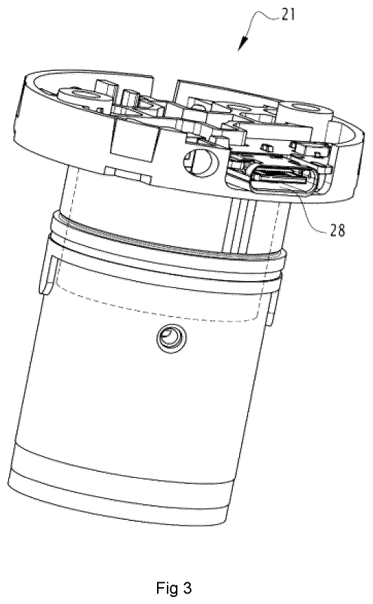

The roller tube 4 is rotated about the axis of rotation X and the casing 17 of the electromechanical actuator 11 by being supported by means of two pivot connections. The first pivot connection is made at a first end of the roller tube 4 by means of the ring arranged around the first end 17a of the casing 17 of the electromechanical actuator 11. The ring thus serves to make a bearing. The second pivot connection is made at a second end of the roller tube 4 opposite the first end. The electromechanical actuator 11 further comprises a torque support 21, which can also be called an “actuator head” or a “fixed point”. An embodiment of the support torque 21 is illustrated in the FIG. 3.

Herein, the torque support 21 is arranged at the first end 17a of the casing 17 of the electromechanical actuator 11, more particularly in the assembled configuration of the electromechanical actuator 11.

The torque support 21 of the electromechanical actuator 11 is configured to fasten the electromechanical actuator 11 to the holding device 23, more particularly onto one of the supports.

Thereby, the torque support 21 serves to take up the forces exerted by the electromechanical actuator 11, more particularly the torque exerted by the electromechanical actuator 11, with respect to the structure of the building B. The torque support 21 advantageously serves to take up, furthermore, the forces exerted by the roller tube 4, in particular the weight of the roller tube 4, of the electromechanical actuator 11 and of the screen 2, and to ensure that the forces are taken up by the structure of the building B.

The torque support 21 protrudes at the first end 17a of the casing 17 of the electromechanical actuator 11.

Thereby, a first part of the torque support 21 is arranged inside the casing 17 and a second part of the torque support 21 is arranged outside the casing 17.

The torque support 21 shuts off, in other words is configured to shut off, the first end 17a of the casing 17, more particularly in the assembled configuration of the electromechanical actuator 11.

Furthermore, the torque support 21 of the electromechanical actuator 11 can be used to support at least part of the electronic control unit 15.

The torque support 21 is configured to be fastened, in other words is fastened, to the casing 17 by means of one or a plurality of fastening elements, not shown, more particularly in the assembled configuration of the electromechanical actuator 11. The fastening element(s) may be, in particular, bossages, fastening screws, elements of fastening by elastic snap-fastening, ribs fitted in notches or a combination of such different fastening elements.

In a first embodiment (not shown), the ring is arranged, in other words is configured to be arranged, around a portion of the casing 17, more particularly in the assembled configuration of the electromechanical actuator 11. In such case, the ring is mounted free to rotate about the casing 17.

In a variant (not shown), the ring is arranged, in other words is configured to be arranged, around the torque support 21, more particularly in the assembled configuration of the electromechanical actuator 11. In such case, the ring is mounted free to rotate about the torque support 21.

In another variant (not shown), the ring is arranged, in other words is configured to be arranged, on the one hand, around the torque support 21 and, on the other hand, around a part of the casing 17, more particularly in the assembled configuration of the electromechanical actuator 11. In such a case, the ring can be mounted free to rotate both about the torque support 21 and about the casing 17.

The output shaft 20 of the electromechanical actuator 11 is arranged inside the roller tube 4 and at least partly outside the casing 17 of the electromechanical actuator 11.

Herein, one end of the output shaft 20 protrudes with respect to the casing 17 of the electromechanical actuator 11, more particularly with respect to the second end 17b of the casing 17.

Advantageously, the output shaft 20 of the electromechanical actuator 11 is configured to rotate, in other words rotates a connecting element, also called a “wheel”. The connecting element is connected to the roller tube 4, more particularly in the assembled configuration of the shading device 3.

When the electromechanical actuator 11 is put into operation, the electric motor 16 and the reduction gear rotate the output shaft 20. Furthermore, the output shaft 20 of the electromechanical actuator 11 rotates the roller tube 4 by means of the connecting element. Thereby, the roller tube 4 rotates the screen 2 of the shading device 3 so as to cover or uncover the opening of the building B.

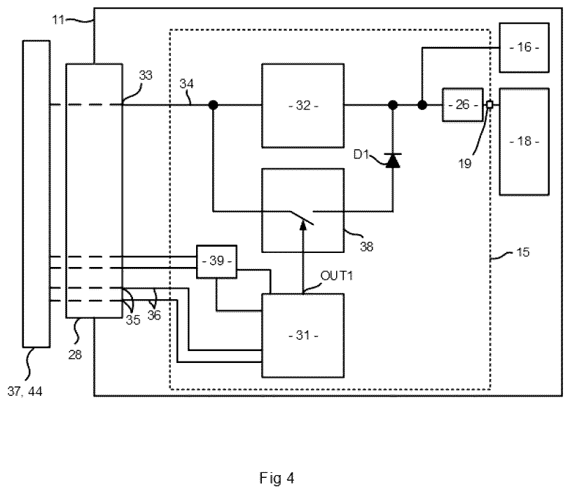

The electronic control unit 15 of the electromechanical actuator 11 will now be described with reference to FIG. 4.

The electronic control unit 15 is arranged, in other words is integrated, inside the casing 17 of the electromechanical actuator 11.

The electronic control unit 15 comprises a controller 31 embedded in the electromechanical actuator 11, and a circuit 32 for charging the rechargeable battery 18.

The charging circuit 32 is connected to the rechargeable battery 18. The charging circuit 32 is specifically configured to charge the rechargeable battery 18 with the electrical energy of a charger 44 electrically connected to the charging circuit 32 via the supply bus 34.

Advantageously, the charging circuit 32 is a Buck Boost Charger.

The electronic control unit 15 comprises at least one electronic board on which the charging circuit 32 and the controller 31 are assembled, the electronic board being arranged, in other words integrated, inside the casing 17 of the electromechanical actuator 11 in the assembled configuration of the electromechanical actuator 11.

The rechargeable battery 18 is configured to supply, in other words supplies electrical energy to the electromechanical actuator 11, more particularly to the electronic control unit 15 and to the electric motor 16.

Advantageously, the rechargeable battery 18 is a Ni-MH battery, or a lithium-ion battery.

The controller 31 is e.g. a microcontroller. Herein, and as a non-limiting example, the controller 31 is an STM32G0B1CE microcontroller.

Advantageously, the electronic control unit 15 further comprises a management module 26 for the rechargeable battery 18, connected between the rechargeable battery 18 and the charging circuit 32. In the event of an electrical fault or of a malfunction of the rechargeable battery 18, e.g. in the event of too high a temperature of the rechargeable battery 18, the management module 26 of the rechargeable battery 18 interrupts, in other words is configured to interrupt, the connection between the charging circuit 32 and the rechargeable battery 18, in order to prevent any damage to the rechargeable battery 18.

The electromechanical actuator 11 comprises a connector 28. The connector 28 comprises at least one power supply pin 33 connected to the charging circuit 32 by a power supply bus 34. In an advantageous embodiment and as shown in FIG. 3, the connector 28 is arranged at the torque support 21, which makes the connector easily accessible to a user, for connecting either a photovoltaic solar panel 37 or a charger 44.

Advantageously, the connector 28 further comprises at least one communication pin 35 connected to the controller 31 by a communication bus 36.

Advantageously, the power supply bus 34 and the communication bus 36 are included separately in a first ribbon of flexible flat cables, also known as the “Flexible Flat Cable” ribbon (FFC), and in a second FFC ribbon, respectively, the first FFC ribbon being distinct from the second FFC ribbon. Each FFC ribbon cable is e.g. at least 1 cm long, and the cables included in each FFC ribbon are not shielded.

In a variant, the supply bus 34 and the communication bus 36 are included in the same FFC ribbon. The FFC ribbon is, e.g. at least 1 cm long, and the cables included in the FFC ribbon are not shielded.

A photovoltaic solar panel 37, not shown in the figures, is configured to be connected to the electromechanical actuator 11. The photovoltaic solar panel 37 is external to the electromechanical actuator 11.

The electronic control unit 15 further comprises means of detection 39, in other words detection elements 39, of a connection of a photovoltaic solar panel 37 to the connector 28. The means of detection 39 cooperate, in other words are configured to cooperate, with the controller 31, in such a way that the controller 31 detects, in other words is configured to detect, a connection of the photovoltaic solar panel 37 to the connector 28. As an example, but in no way limited to, the means of detection 39 may comprise a voltage divider bridge to which is applied, at the input, an input voltage supplied by the electronic control unit 15 through the connector 28, the electronic control unit 15 being configured to measure an output voltage of the voltage divider bridge in order to compare same with a target voltage value, and to infer therefrom the connection of the photovoltaic solar panel 37 to the connector 28. In a variant, other means of detection that are more sophisticated and hence more expensive can be envisaged, implementing, e.g., communication between the electromechanical actuator 11 and the photovoltaic solar panel 37 via the connector 28, the photovoltaic solar panel 37 being in such case provided with means of communication suitable for communicating with the electronic control unit 15 of the electromechanical actuator 11.

A charger 44, not shown in the figures, is configured to be connected to the electromechanical actuator 11. The charger 44 is external to the electromechanical actuator 11.

Advantageously, the charger 44 is a smart charger connected to an electrical power supply source, e.g. to the mains, or is an auxiliary power unit, e.g. another battery external to the electromechanical actuator 11 enabling electronic devices to be recharged without using an electrical socket, the auxiliary power unit being in such case commonly called a Power Bank.

Advantageously, the smart charger 44 comprises hardware and software elements suitable for communicating with the controller 31 of the electromechanical actuator 11 via the communication bus 36.

According to a first embodiment of the electromechanical actuator 11, shown in FIG. 4, the electronic control unit 15 further comprises a first switch 38, the first switch being arranged in the power supply bus 34 between the power supply pin 33 of the connector 28 and the means of connection 19 to the rechargeable battery 18. In other words, the first switch 38 is connected both to the connector 28 via the supply bus 34 and to the means of connection 19 to the rechargeable battery 18.

The first switch 38 is connected in parallel with the charging circuit 32.

As an example, but in no way limited to, the first switch 38 may include one or a plurality of N-MOSFETs. However, other embodiments are conceivable.

The controller 31 comprises a first controllable output OUT1 which cooperates, in other words is configured to cooperate, with the first switch 38. The first switch 38 is arranged in the power supply bus 34 in such a way that the first switch 38 permits the flow of a current in the power supply bus 34 between the power supply pin 33 of the connector 28 and the rechargeable battery 18 when the first switch 38 is controlled in a closed state, and interrupts the flow of a current in the power supply bus 34 between the power supply pin 33 of the connector 28 and the rechargeable battery 18 when the second switch 42 is controlled in an open state.

The first switch 38 is controlled in a closed state by the first controllable output OUT1 of the controller 31 when a connection of a photovoltaic solar panel 37 to the connector 28 is detected, so as to electrically connect the power supply bus 34 to the rechargeable battery 18. In such way, the controller 31 authorizes the flow of a current between the photovoltaic solar panel 37 and the rechargeable battery 18 when the controller detects the connection of the photovoltaic solar panel 37 to the connector 28, thus making it possible to direct the most part of the current produced by the photovoltaic solar panel 37 directly to the rechargeable battery 18, while preventing directing said most part of the current toward the charging circuit 32. Indeed, the efficiency of the charging circuit 32 would be poor if the charging circuit were to transform the current coming from the photovoltaic solar panel 37, the current being on average much lower than the current from a charger for which the charging circuit 32 is specifically configured. The consumption of the electromechanical actuator 11 is thereby improved. In other words, the electronic control unit 15 includes means 38 configured to short-circuit, in other words, means 38 short-circuiting the charging circuit 32, when a connection of a photovoltaic solar panel 37 to the connector 28 is detected.

Advantageously, the first output OUT1 electrically connects the power supply bus 34 to the means of connection 19 to the rechargeable battery 18 via a diode so that a current coming from the rechargeable battery 18 is blocked toward the power supply bus 34.

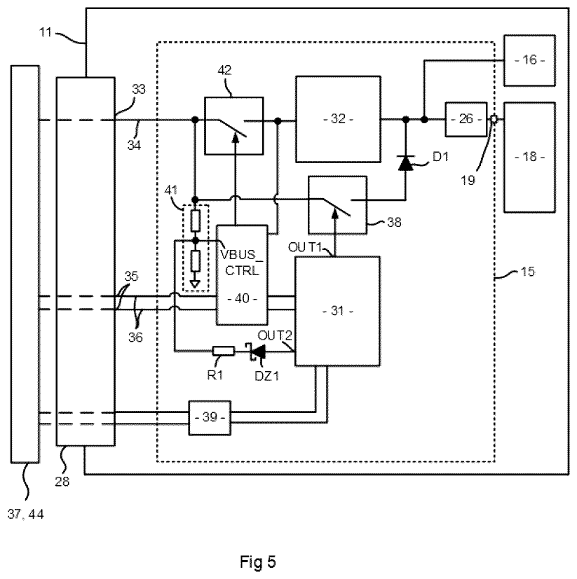

According to a second advantageous embodiment of the electromechanical actuator 11, shown in FIG. 5, the electromechanical actuator 11 further comprises a protection circuit 40, more particularly a circuit for protection against overvoltages. The protection circuit 40 cooperates, in other words is configured to cooperate, with a second switch 42 external to the protection circuit 40. The second switch 42 is arranged in the power supply bus 34 in such a way that the second switch 42 permits the flow of a current in the power supply bus 34 between the power supply pin 33 of the connector 28 and the charging circuit 32 when the second switch 42 is controlled in a closed state, and interrupts the flow of a current in the power supply bus 34 between the power supply pin 33 of the connector 28 and the charging circuit 32 when the second switch 42 is controlled in an open state.

The first switch 38 is connected in parallel with the second switch 42 and with the charging circuit 32.

Advantageously, the protection circuit 40 comprises a voltage input VBUS_CTRL connected to the power supply bus 34 via a resistor bridge 41, more particularly configured so as to form a voltage divider bridge. The resistor bridge 41 is configured to adapt the voltage of the power supply bus 34 to the voltage input VBUS_CTRL, so that a nominal and/or maximum value of the voltage of the power supply bus 34 can be detected by the protection circuit 40, and also so that an overvoltage of the voltage of the power supply bus 34 can be detected by the protection circuit 40. More particularly, the resistor bridge 41 is configured to decrease the voltage of the power supply bus 34 at the voltage input VBUS_CTRL. As an example, but in no way limited to, the nominal and/or maximum value of the voltage of the power supply bus 34 detected by the protection circuit 40 via the resistor bridge 41 is strictly less than 1.2 volts, and an overvoltage value of the voltage of the power supply bus 34 detected by the protection circuit 40 via the resistor bridge 41 is greater than or equal to 1.2 volts.

Advantageously, the second switch 42 is controlled in an open state by the protection circuit 40 when the protection circuit 40 detects an overvoltage on the voltage input VBUS_CTRL. Thereby configured, the protection circuit 40, by cooperating with the second switch 42, serves to detect an overvoltage in the power supply bus 34 and, in response, to interrupt the flow of a current in the power supply bus 34 between the power supply pin 33 of the connector 28 and the charging circuit 32, in order to protect the charging circuit 32 from the overvoltage.

Advantageously, the controller 31 further comprises a second controllable output OUT2 which cooperates, in other words which is configured to cooperate, with the voltage input VBUS_CTRL of the protection circuit 40. The second controllable output OUT2 is electrically connected to the voltage input VBUS_CTRL. When a connection of the photovoltaic solar panel 37 to the power supply connector 28 is detected, the controller 31 controls, in other words is configured to control, the second controllable output OUT2, so as to simulate an overvoltage on the voltage input VBUS_CTRL, e.g. greater than or equal to 1.2 volts. Such configuration of the electronic control unit 15 enables the controller 31 to simulate an overvoltage on the voltage input VBUS_CTRL when the controller detects the connection of a photovoltaic solar panel 37 to the connector 28, automatically leading to opening of the second switch 42 by the protection circuit 40, and thereby interrupting the flow of a current in the power supply bus 34 between the connector 28 and the charging circuit 32.

Furthermore, the first switch 38 is controlled in a closed state by the first controllable output OUT1 of the controller 31 when the connection of the photovoltaic solar panel 37 to the connector 28 is detected, so as to electrically connect the power supply bus 34 to the rechargeable battery 18. The controller 31 thereby permits the direct flow of a current between the photovoltaic solar panel 37 and the rechargeable battery 18, thereby making it possible to direct most part of the current produced by the photovoltaic solar panel 37 directly to the rechargeable battery 18, while preventing to direct the most part of the current to the charging circuit 32.

For example, the second switch 42 opens and then the first switch 38 closes. Such order is in no way limiting. Indeed, in another example, the first switch 38 closes and then the second switch 42 opens, or in another example, the opening of the second switch 42 and the closing of the first switch 38 are simultaneous.

In such way, the charging circuit 32 does not consume current when a photovoltaic solar panel 37 is connected to the connector 28, thereby reducing the consumption of the electromechanical actuator 11 when a photovoltaic solar panel 37 is connected to the connector 28.

Advantageously, the second controllable output OUT2 is electrically connected to the voltage input VBUS_CTRL via a resistor and a Zener diode which are connected together in series. In such way, the Zener diode and the resistor cooperate together with the resistor bridge 41 so that, when the second controllable output OUT2 is controlled, a voltage value corresponding to an overvoltage, e.g. 1.2 volts, is applied to the voltage input of the VBUS_CTRL of the protection circuit 40, thereby simulating an overvoltage on the voltage input of the VBUS_CTRL of the protection circuit 40, leading to the opening of the second switch 42.

According to the first embodiment and the second embodiment, the connector 28 is advantageously a universal serial bus connector, or USB connector of type C, also known as USB-C or USB Type-C. According to such embodiment, the USB Type-C connector comprises a power supply pin VBUS, and two communication pins CC1, CC2 dedicated to the communication of signals of the USB Power Delivery type.

Also, according to said embodiment, the controller 31 is a USB-C controller which contains a combination of software components, commonly referred to as a USB Power Delivery stack, also called a USB-PD stack.

In the case of the second embodiment, the protection circuit 40 is a USB Type-C Port Protection circuit.

For safe and reliable implementation of USB Type-C, the USB Type-C port protection circuit provides overvoltage protection on the CC1 and CC2 communication pins when the pins are short-circuited to the VBUS power pin, which can occur when removing a USB Type-C cable from the connector 28. The USB type-C port protection circuit controls the second switch 42, e.g. of the N-MOSFET type, when a defective power supply applies a voltage greater than a predetermined threshold, herein a voltage greater than 1.2 volts.

Advantageously, and in combination with such embodiment of the electromechanical actuator 11, the smart charger 44 comprises hardware and software elements compatible with, in other words configured to implement, the “USB Power Delivery” standard, also called “USB-PD”, more particularly the “USB Power Delivery 3.0” standard, also called “USB-PD 3.0”.

1. An electromechanical actuator for a sun protection or a privacy device, the electromechanical actuator comprising at least:
an electric motor,
an electronic control unit,
a connection device to at least one rechargeable battery, and
a connector, the connector being configured to be connected to a photovoltaic solar panel or to a charger,
the electronic control unit comprising at least:
a charging circuit, the charging circuit being, on the one hand, connected to the connection device to the at least one rechargeable battery, and, on the other hand, electrically connected to the connector via a power supply bus,
a controller, and
a detector for detecting a connection of the photovoltaic solar panel to the connector, the electronic control unit further comprising at least:
a first switch, the first switch being connected, on the one hand, to the connector via the power supply bus, and, on the other hand, to the connection device to the at least one rechargeable battery, and
the controller being configured to control the first switch in a closed state by means of a first controllable output of the controller when a connection of a photovoltaic solar panel to the connector is detected, so as to electrically connect the power supply bus to the connection device to the least one rechargeable battery.

2. The electromechanical actuator according to claim 1, wherein the first switch is connected in parallel with the charging circuit such that the first switch short-circuits the charging circuit when the first switch is controlled by the first controllable output of the controller.

3. The electromechanical actuator according to claim 1, wherein the first output electrically connects the power supply bus to the connection device to the at least one rechargeable battery via a diode such that a current from the rechargeable battery is blocked toward the power supply bus.

4. The electromechanical actuator according to claim 1, wherein the connector is a USB Type-C connector, the controller is a USB Type-C controller, and the USB Type-C controller is connected to at least one communication pin of the Universal Serial Bus Type-C connector via a communication bus.

5. The electromechanical actuator according to claim 1, wherein the electronic control unit further comprises at least:
a protection circuit, the protection circuit being connected to the connector via a communication bus, and comprising a voltage input, the voltage input being connected to the power supply bus via a resistor bridge, and
a second switch, the second switch being connected, on the one hand, to the power supply bus, and, on the other hand, to the charging circuit, the second switch being controlled in an open state by a protection circuit when the protection circuit detects an overvoltage at the voltage input, and
wherein the controller further comprises a second controllable output electrically connected to the voltage input, and the controller is configured to control the second controllable output when the connection of the photovoltaic solar panel to the connector is detected, so as to simulate an overvoltage at the voltage input.

6. The electromechanical actuator (11) according to claim 5, wherein the second controllable output connected to the voltage input via a resistor and a Zener diode which are connected together in series.

7. The electromechanical actuator according to claim 5, wherein the connector is a USB Type-C connector, the controller is a USB Type-C controller, and the protection circuit is a USB Type-C port protection circuit.

8. The electromechanical actuator according to claim 6, wherein the connector is a USB Type-C connector, the controller is a USB Type-C controller, and the protection circuit is a USB Type-C port protection circuit.

9. A sun protection or privacy device comprising at least one roller tube, a screen which can be rolled around the roller tube, an electromechanical actuator comprising at least:
an electric motor,
an electronic control unit,
a connection device to at least one rechargeable battery, and
a connector, the connector being configured to be connected to a photovoltaic solar panel or to a charger,
the electronic control unit comprising at least:
a charging circuit, the charging circuit being, on the one hand, connected to the connection device to the at least one rechargeable battery, and, on the other hand, electrically connected to the connector via a power supply bus,
a controller, and
a detector for detecting a connection of the photovoltaic solar panel to the connector, the electronic control unit further comprising at least:
a first switch, the first switch being connected, on the one hand, to the connector via the power supply bus, and, on the other hand, to the connection device to the at least one rechargeable battery, and
the controller being configured to control the first switch in a closed state by means of a first controllable output of the controller when a connection of a photovoltaic solar panel to the connector is detected, so as to electrically connect the power supply bus to the connection device to the least one rechargeable battery,
the electromechanical actuator being further configured to rotate the roller tube, the electromechanical actuator further comprising a torque support, the torque support comprising the connector.

10. A method of charging at least one rechargeable battery configured to supply power to an electromechanical actuator for a sun protection or a privacy device, the electromechanical actuator comprising at least:
an electric motor,
an electronic control unit,
a connection device to at least one rechargeable battery, and
a connector, the connector being configured to be connected to a photovoltaic solar panel or to a charger,
the electronic control unit comprising at least:
a charging circuit, the charging circuit being, on the one hand, connected to the connection device to the at least one rechargeable battery, and, on the other hand, electrically connected to the connector via a power supply bus,
a controller, and
a detector for detecting a connection of the photovoltaic solar panel to the connector, the electronic control unit further comprising at least:
a first switch, the first switch being connected, on the one hand, to the connector via the power supply bus, and, on the other hand, to the connection device to the at least one rechargeable battery, and
the controller being configured to control the first switch in a closed state by means of a first controllable output of the controller when a connection of a photovoltaic solar panel to the connector is detected, so as to electrically connect the power supply bus to the connection device to the least one rechargeable battery, the method being implemented by the electronic control unit, and comprising at least:
a step of detecting a connection of the photovoltaic solar panel to the connector,
when a connection of the photovoltaic solar panel to the connector is detected, a step of controlling the first switch in a closed state so as to electrically connect the power supply bus to the connection device to the at least one rechargeable battery.

11. A method of charging at least one rechargeable battery configured to supply power to an electromechanical actuator for a sun protection or a privacy device, the electromechanical actuator comprising at least:
an electric motor,
an electronic control unit,
a connection device to at least one rechargeable battery, and
a connector, the connector being configured to be connected to a photovoltaic solar panel or to a charger,
the electronic control unit comprising at least:
a charging circuit, the charging circuit being, on the one hand, connected to the connection device to the at least one rechargeable battery, and, on the other hand, electrically connected to the connector via a power supply bus,
a controller, and
a detector for detecting a connection of the photovoltaic solar panel to the connector, the electronic control unit further comprising at least:
a first switch, the first switch being connected, on the one hand, to the connector via the power supply bus, and, on the other hand, to the connection device to the at least one rechargeable battery, and
the controller being configured to control the first switch in a closed state by means of a first controllable output of the controller when a connection of a photovoltaic solar panel to the connector is detected, so as to electrically connect the power supply bus to the connection device to the least one rechargeable battery, the electronic control unit further comprising at least:
a protection circuit, the protection circuit being connected to the connector via a communication bus, and comprising a voltage input, the voltage input being connected to the power supply bus via a resistor bridge, and
a second switch, the second switch being connected, on the one hand, to the power supply bus, and, on the other hand, to the charging circuit, the second switch being controlled in an open state by a protection circuit when the protection circuit detects an overvoltage at the voltage input, and
wherein the controller further comprises a second controllable output electrically connected to the voltage input, and the controller is configured to control the second controllable output when the connection of the photovoltaic solar panel to the connector is detected, so as to simulate an overvoltage at the voltage input,
the method being implemented by the electronic control unit, and comprising at least:
a step of detecting a connection of the photovoltaic solar panel to the connector,
when a connection of the photovoltaic solar panel to the connector is detected, a first step of controlling the first switch in a closed state, so as to electrically connect the power supply bus to the connection device to the at least one rechargeable battery, and
when a connection of the photovoltaic solar panel to the connector is detected, a step of controlling the second controllable output so as to simulate an overvoltage at the voltage input making the second switch to switch to the open state.
